(19) United States
(12) Patent Application Publication
(10) Pub. No.: US 2010/0042751 A1
(43) Pub. Date: Feb. 18, 2010

(54) DATA TRANSFER CONTROL DEVICE, DATA TRANSFER DEVICE, DATA TRANSFER CONTROL METHOD, AND SEMICONDUCTOR INTEGRATED CIRCUIT USING RECONFIGURED CIRCUIT

(76) Inventors: Kouichi Ishino, Hyogo (JP); Takashi Morimoto, Osaka (JP); Koji Asai, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/522,490

(22) PCT Filed: Oct. 24, 2008
(86) PCT No.: PCT/JP2008/003016

§ 371 Date: Jul. 8, 2009

(30) Foreign Application Priority Data
Nov. 9, 2007 (JP) 2007-291490

(51) Int. Cl. G06F 3/00

(52) U.S. Cl. 710/8

(57) ABSTRACT

A semiconductor integrated circuit ensures to reserve a required memory bandwidth at low cost. A memory bandwidth monitoring unit 1210 calculates a required memory bandwidth, monitors the usage condition of the memory, and outputs the following information to a reconfiguration control unit 1120. The information is necessary to reconfigure a reconfiguration unit 1110 into a logic unit and a temporary buffer both of which are scalable depending on the usage condition. According to information, the reconfiguration control unit 1120 controls the reconfiguration unit 1110. The buffer is for storing data accessed to or from the memory by each bus master. The logic unit acts as a bus master that only uses a portion of the memory bandwidth that remains unused during the time no access request to the data storage unit 1002 issued by a bus master unit having a higher priority level is being executed.

### TECHNICAL FIELD

The present invention relates to a technique of transferring, within a semiconductor integrated circuit, data between each of a plurality of bus masters with memory via a bus. Especially, the present invention relates to a technique to improve data transfer performance.

### BACKGROUND ART

Conventionally, within a semiconductor integrated circuit having memory and a plurality of bus masters and buses, each bus master transfers data to and from the memory via a corresponding one of the buses. According to Patent Document 1 listed below, a slave device such as memory is provided with a buffer for temporarily storing bus access data and a bus control device improves the system performance by arbitrating amongst a plurality of parallel or time-shared buses.

Further, according to Patent Document 2 also listed below, a reconfiguration circuit is provided with an integrated array of a large number of combinational circuits each having memory cells and switching elements. The reconfiguration circuit is also provided with a control circuit for controlling whether to use the memory function or the logic function of each combinational circuit.

### [Patent Document 1]

JP Patent Application Publication No. 10-214249

### [Patent Document 2]

JP Patent Application Publication No. 04-252515

### DISCLOSURE OF THE INVENTION

### Problems the Invention is Attempting to Solve

Unfortunately, however, the conventional techniques described above require a dedicated buffer in order to reserve the memory bandwidth, which undesirably increase the circuit area and cost.

To address the conventional problems noted above, the present invention aims to provide a data transfer control device, a data transfer device, a data transfer control method, and a semiconductor integrated circuit each of which improves the data transfer performance by ensuring a memory bandwidth required for data transfer, without the need to increase the circuit area and cost.

### Means for Solving the Problems

In order to achieve the above aim, one aspect of the present invention provides a data transfer control device for controlling transfer of data to and from an external device. The data transfer control device includes: a reconfiguration unit having a plurality of reconfigurable circuit cells; an internal device operable to output a data transfer request; a transfer control unit operable to relay data transferred between the internal device and the external device and to acquire reconfiguration information defining a circuit assisting the data transfer, the circuit being determined depending on a memory bandwidth required by the data transfer request; and a reconfiguration control unit operable to control the reconfiguration unit to configure the circuit according to the acquired reconfiguration information.

### Effects of the Invention

With this structure, the reconfiguration unit is controlled to configure a circuit according to the reconfiguration information defining the circuit for assisting the data transfer. The circuit is determined depending on the memory bandwidth required for data transfer between the internal device and the external device. This allows the circuit configured by the reconfiguration unit to assist the data transfer, without the need to increase the circuit area and cost.

Preferably, the data transfer control unit is operable to acquire the reconfiguration information if the memory bandwidth is equal to or greater than a predetermined threshold. The reconfiguration control unit is operable to control the reconfiguration unit to configure the circuit according to the reconfiguration information.

With this structure, if the memory bandwidth is equal to or greater than the predetermined threshold, the circuit configured by the reconfiguration unit is capable of assisting the data transfer.

Preferably, the transfer control unit is operable to acquire the reconfiguration information defining the circuit acting as a buffer unit operable to temporarily store data requested to be transferred by the data transfer request. The reconfiguration control unit is operable to control the reconfiguration unit to configure the circuit acting as the buffer unit.

With this structure, the reconfiguration unit configures the circuit acting as the buffer unit, so that the data transfer is carried out with the use of the buffer.

Preferably, the reconfiguration information additionally defines a circuit acting as one of an arithmetic unit and a control unit. The reconfiguration control unit is operable to control the reconfiguration unit to additionally configure the circuit acting as a corresponding one of the arithmetic unit and the control unit.

Preferably, the data transfer control device further includes a status holding unit that is operable to hold, immediately prior to reconfiguration by the reconfiguration unit, a processing status of each circuit currently preset in the reconfiguration unit.

Preferably, the reconfiguration unit is operable to reconfigure the previously configured circuits, by using the processing status held in the processing status holding unit.

Preferably, the transfer control unit is operable to acquire, if the memory bandwidth is smaller than a predetermined threshold, the circuit reconfiguration information defining the circuit acting as one of an arithmetic unit and a control unit. The reconfiguration control unit is operable to control, if the memory bandwidth is smaller than the predetermined threshold, the reconfiguration unit to configure the circuit acting as a corresponding one of the arithmetic unit and the control unit.

With this structure, if the memory bandwidth is smaller than the predetermined threshold, the reconfiguration unit configures the circuit acting as one of the arithmetic unit and the control unit. That is, the circuit is configured as an initial setting circuit that is not used for the data transfer.

Preferably, the transfer control unit is operable to (i) acquire, if the memory bandwidth is smaller than a predetermined threshold, the reconfiguration information defining the circuit acting as one of an arithmetic unit and a control unit and (ii) acquire, if the memory bandwidth is equal to or greater than the predetermined threshold, the reconfiguration information defining the circuit acting as a buffer unit operable to temporarily store data requested to be transferred by the data transfer request. The reconfiguration control unit is operable to (i) control, if the memory bandwidth is smaller than the predetermined threshold, the reconfiguration unit to configure the circuit to configure the circuit acting as a corresponding one of the arithmetic unit and the control unit and (ii) control, if the memory bandwidth is equal to or greater than the predetermined threshold, the reconfiguration unit to configure the circuit to acting as the buffer unit. The data transfer control device further includes: a status holding unit operable to hold, immediately prior to reconfiguration by the reconfiguration unit, a processing status of each circuit currently present in the reconfiguration unit.

With this structure, if the memory bandwidth is equal to or greater than the predetermined threshold, the reconfiguration unit configures the circuit that assists the data transfer. In addition, if the memory bandwidth is smaller than the predetermined threshold, the reconfiguration unit configures the circuit acting as one of the arithmetic unit and the control unit. That is, the circuit is configured as an initial setting circuit that is not used for the data transfer.

Preferably, if any memory bandwidth remains unused during a time period in which no data transfer request issued by the internal device is being executed, the reconfiguration unit is operable to reconfigure the circuit acting as the corresponding one of the arithmetic unit and the control units that only uses the remaining memory bandwidth.

Preferably, the transfer control unit is operable to (i) acquire, if the memory bandwidth is smaller than a predetermined threshold, the reconfiguration information defining the circuit acting as one of an arithmetic unit and a control unit and (ii) acquire, if the memory bandwidth is equal to or greater than the predetermined threshold, the reconfiguration information defining the circuit acting as one of the arithmetic unit and the control unit and additionally defining a circuit acting as a buffer unit operable to temporarily store data requested to be transferred by the data transfer request. The reconfiguration control unit is operable to (i) control, if the memory bandwidth is smaller than the predetermined threshold, the reconfiguration unit to configure the circuit acting as a corresponding one of the arithmetic unit and the control unit, and (ii) control, if the memory bandwidth is equal to or greater than the predetermined threshold, the reconfiguration unit to configure the circuit acting as a corresponding one of the arithmetic unit and the control unit and additionally configure the circuit acting as the buffer unit.

Preferably, the data transfer control device further includes: a status holding unit operable to hold, immediately prior to reconfiguration by the reconfiguration unit, a processing status of each circuit currently present in the reconfiguration unit.

Preferably, the transfer control unit is operable to acquire, if the memory bandwidth is equal to or greater than the predetermined threshold, the reconfiguration information defining the circuit acting as one of the arithmetic unit and the control unit operable to access the buffer unit. The reconfiguration control unit is operable to control, if the memory bandwidth is equal to or greater than the predetermined threshold, the reconfiguration unit to configure the circuit acting as the corresponding one of the arithmetic unit and the control unit operable to access the buffer unit.

Preferably, if the transfer request issued by the internal device that is required to respond in real-time is assigned with a high priority level and any memory bandwidth remains unused during a time period in which no data transfer request issued by the internal device is being executed, the reconfiguration unit is operable to configure the corresponding one of the arithmetic unit and the control units that only uses the remaining memory bandwidth.

According to another aspect, the present invention provides a data transfer device for transferring data between internal devices. The data transfer device includes a reconfiguration unit having a plurality of reconfigurable circuit cells; a first device operable to output a data transfer request; a second device being a destination of data transfer requested by the data transfer request; a transfer control unit operable to relay data transferred between the first and second devices and to acquire reconfiguration information defining a circuit assisting the data transfer, the circuit being determined depending on a memory bandwidth required by the data transfer request; and a reconfiguration control unit operable to configure the circuit according to the acquired reconfiguration information.

Preferably, the data transfer device is a real-time device for performing real-time processing. The second device is a storage device operable to store data. The first device is required to respond in real-time and operable to output a request to read or write data to or from the storage device.

According to yet another aspect, the present invention provides a semiconductor integrated circuit for relaying data transferred between an internal device and an external device that is a destination of requested data transfer. The semiconductor integrated circuit includes: a reconfiguration unit having a plurality of reconfigurable circuit cells; the internal device operable to output a data transfer request; a transfer control unit operable to relay data transferred between the internal device and the external device and to acquire reconfiguration information defining a circuit assisting the data transfer, the circuit being determined depending on a memory bandwidth required by the data transfer request; and a reconfiguration control unit operable to control the reconfiguration unit to configure the circuit according to the acquired reconfiguration information.

As described above, the present invention is provided with the reconfiguration circuit that allows the arithmetic unit or the control unit to be used as a buffer, during the time such a unit is being excessive and unnecessary in the system operation. As a consequence, the effective use of the memory bandwidth is ensured at low cost.

### BRIEF DESCRIPTION OF THE DRAWINGS

FIG. 1 shows a basic structure of a consumer appliance 10;

FIG. 2 shows a structure of a reconfiguration unit 1110;

FIG. 3 shows a structure of a logic circuit 4011;

FIG. 4 shows a data structure of a status holding table 5000;

FIG. 5 shows a structure of a memory bandwidth monitoring unit 1210;

FIG. 6 shows a data structure of a threshold table 3000;

FIG. 7 shows another data structure of the threshold table 3000;

FIG. 8 is a flowchart showing an overview of a processing flow of the consumer appliance 10;

FIG. 9 is a flowchart showing the processing flow of the consumer appliance 10 (Continued in FIG. 10);

FIG. 10 is the flowchart showing the processing flow of the consumer appliance 10 (Continued in FIG. 11);

FIG. 11 is the flowchart showing the processing flow of the consumer appliance 10 (Continued in FIG. 12);

FIG. 12 is the flowchart showing the processing flow of the consumer appliance 10 (Continued from FIG. 11);

FIG. 13 is a flowchart showing a processing flow of acquiring reconfiguration information;

FIG. 14 is a flowchart showing a processing flow of reconfiguring the reconfiguration circuit; and

FIG. 15 is a view illustrating a transition of a circuit configuration of the reconfiguration circuit 1110.

### REFERENCE NUMERALS

10 Consumer Appliance

100 Semiconductor Integrated Circuit

1000 Bus Master Unit A

1001 Bus Master Unit B

1002 Data Storage

1003 Bus Unit

1004 Bus Unit

1005 Bus Unit

1006 Bus Unit

1007 Bus Unit

1100 Reconfiguration Circuit

1110 Reconfiguration Unit

1111 Logic Unit

1112 Buffer Unit

1120 Reconfiguration Control Unit

1130 Status Holding Unit

1200 Data Transfer Control Unit

1210 Memory Bandwidth Monitoring Unit

1220 Buffer Access Request Unit

2000 Memory Bandwidth Calculating Unit

2001 Threshold Holding Unit

2002 Memory Bandwidth Comparing Unit

2003 Memory Bandwidth Notifying Unit

4000 Buffer Control Unit

4002 Status Management Unit

4005 Arithmetic Data Request Unit

### BEST MODE FOR CARRYING OUT THE INVENTION

The following describes a consumer appliance 10 as one embodiment of the present invention, with reference to the drawings.

### Embodiment

### 1. Structure of Consumer Appliance 10

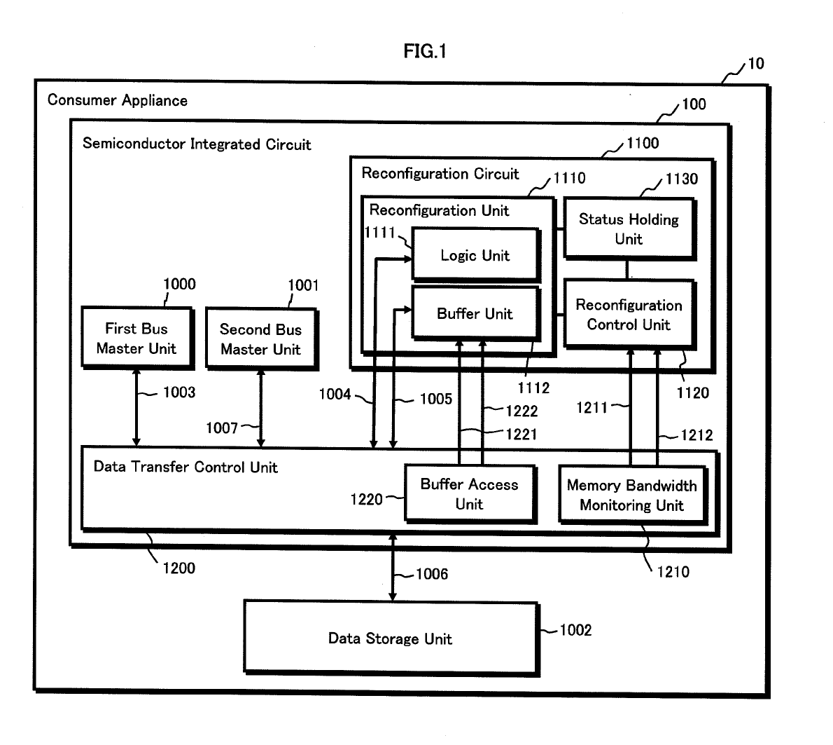

Examples of the consumer appliance 10 include a digital broadcast receiver, a mobile phone, and a DVD player. The consumer appliance 10 is a real-time processing device that performs processes required to be handled in real-time, such as video playback or music playback, with priority over other processes. FIG. 1 shows a basic structure of the consumer appliance 10.

As shown in FIG. 1, the consumer appliance 10 includes a semiconductor integrated circuit 100, a data storage unit 1002, and other component units not shown in the figure. The semiconductor integrated circuit 100 is connected to the data storage unit 1002 via a bus unit 1006. The semiconductor integrated circuit 100 includes a first bus master unit 1000, a second bus master unit 1001, a data transfer control unit 1200, and a reconfiguration circuit 1100. The first bus master unit 1000 is connected to the data transfer control unit 1200 via a bus unit 1003. The second bus master unit 1001 is connected to the data transfer control unit 1200 via a bus unit 1007. A logic unit 1111, which will be described later, is connected to the data transfer control unit 1200 via a bus unit 1004. A buffer unit 1112, which will be described later, is connected to the data transfer control unit 1200 via a bus unit 1005.

For the sake of simplicity, the semiconductor integrated circuit 100 is described as having only two bus master units, which are the first bus master unit 1000 and the second bus master unit 1001. Yet, the semiconductor integrated circuit 100 may have three or more bus master units.

Note that the first bus master unit 1000, the second bus master unit 1001, and the data storage unit 1002 may also referred to as first, second, and third devices, respectively.

### 1.1 First Bus Master Unit 1000 and Second Bus Master Unit 1001

In one example, the first bus master unit 1000 is a control circuit for providing control so that a digital broadcast program is received and the received program is stored as program data. More specifically, the first bus master unit 1000 tunes in to a user-requested channel, selectively extracts a user-requested program from a broadcast wave received on the channel, and stores the extracted program to the data storage unit 1002. Note that the process of extracting a program from a received broadcast wave needs to be performed in real time. The second bus master unit 1001 is, in one example, a circuit for playback of a program. More specifically, the data storage unit 1002 reads a stored program from the data storage unit 1002, reproduces video and audio signals from the read program, and outputs the reproduced video and audio signals to an external monitor device. Note that the process of reproducing and outputting the video and audio signal of a program needs to be performed in real time

The first and second bus master units 1000 and 1001 each output a data transfer request to the data transfer control unit 1200. Note that examples of data transfer requests include a request to write data to the data storage unit 1002 and a request to read data from the data storage unit 1002.

Regarding access to the data storage unit 1002, for example, the first bus master unit 1000 is assigned a higher priority level than that assigned to the second bus master unit 1001. In the case where the first and second bus master units 1000 and 1001 simultaneously issue data transfer requests, the accesses are arbitrated by the data transfer control unit 1200 according to the priority levels.

### 1.2 Reconfiguration Circuit 1100

The reconfiguration circuit 1100 is capable of altering its internal circuit configuration dynamically during the time the consumer appliance 10 is processing.

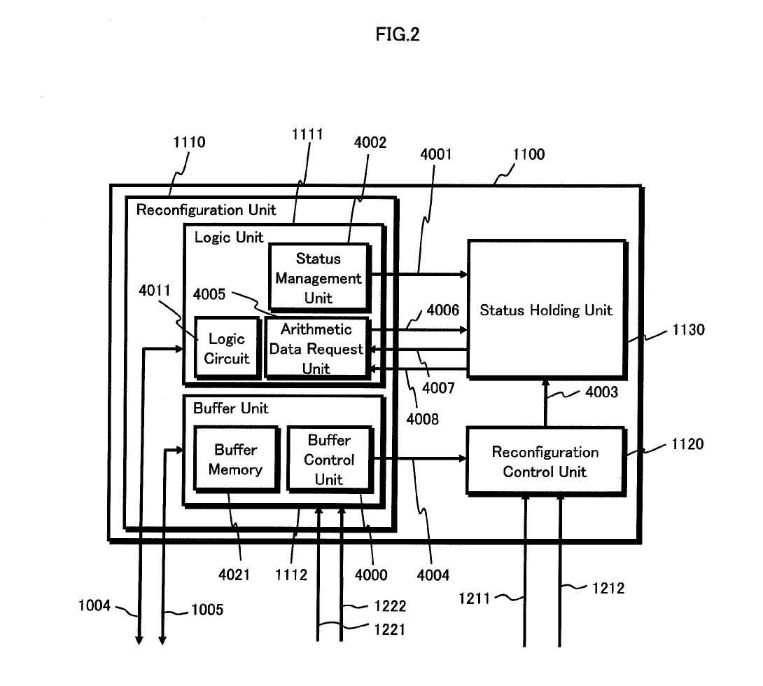

As shown in FIGS. 1 and 2, the reconfiguration circuit 1100 includes a reconfiguration unit 1110, a reconfiguration control unit 1120, and a status holding unit 1130. Note that the reconfiguration unit 1110 comprises a variable circuit whose circuit configuration is dynamically changeable. In contrast, the reconfiguration control unit 1120 and the status holding unit 1130 each comprise a stationary circuit whose circuit configuration cannot be changed.

### (1) Reconfiguration Unit 1110

The reconfiguration unit 1110 is a circuit whose circuit configuration is dynamically changeable. Under control by the reconfiguration control unit 1120, the reconfiguration unit 1110 alters its circuit configuration to configure the logic unit 1111 and the buffer unit 1112 according to reconfiguration information, which will be described later. The logic unit 1111 is for performing arithmetic and control operations, whereas the buffer unit 1112 is for storing data.

As shown in FIG. 2, the reconfiguration unit 1110 after the circuit configuration includes the logic unit 1111 and the buffer unit 1112. The logic unit 1111 includes a status management unit 4002, an arithmetic data request unit 4005, and a logic circuit 4011. The buffer unit 1112 includes a buffer control unit 4000 and a buffer memory 4021.

Suppose that the first bus master unit 1000 has a higher priority level than the second bus master unit 1001, regarding access to the data storage unit 1002 and that the first bus master unit 1000 outputs an access request to the data storage unit 1002 that requires a real-time response. During the time the access request by the first bus master unit 1000 is not yet output (i.e., during the time no access request remains pending) and thus the access request is not yet executed (i.e., during the time no access request is being executed), a portion of the available memory bandwidth may remain unused. In such a case, the reconfiguration unit 1110 configures the logic unit 1111 and the buffer unit 1112. The reconfiguration unit 1110 implements, as an additional bus master unit, either an arithmetic circuit or control circuit. The bus master unit operates by using only the remaining portion of the memory bandwidth. The buffer unit 1112 is for temporal data storage.

### (Arithmetic Data Request Unit 4005)

The arithmetic data request unit 4005 outputs an arithmetic data request signal 4006 to the status holding unit 1130, if data saved to the status holding unit 1130 is required in order to alter the circuit configuration of the logic unit 1111 to newly configure the logic circuit 4011 in response to a reconfiguration request signal 1211 received during an arithmetic operation. In return to the arithmetic data request signal 4006, the arithmetic data request unit 4005 receives, from the status holding unit 1130, a piece of saved arithmetic data 4008 and an instruction signal 4007.

### (Logic Circuit 4011)

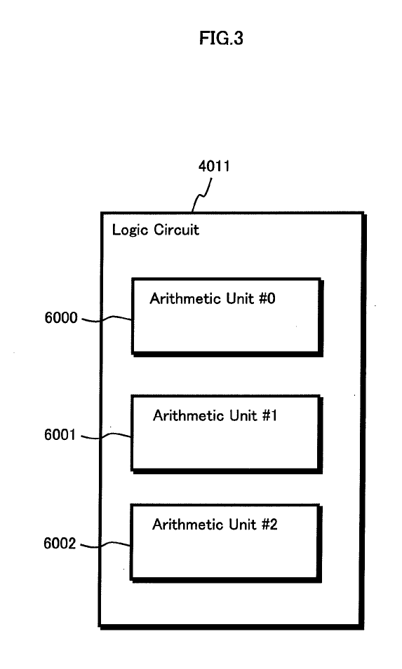

The logic circuit 4011 is reconfigurable depending on the usage of the consumer appliance 10 by the user. FIG. 3 shows one example of the logic circuit 4011.

As a result of reconfiguration, the logic circuit 4011 as in the example shown in FIG. 3 includes a plurality of arithmetic units 6000, 6001, and 6002. The respective arithmetic units have their respective arithmetic results. After completing an arithmetic operation, the arithmetic unit 6000 outputs the arithmetic result to the arithmetic unit 6001. The arithmetic unit 6001 performs an arithmetic operation using the arithmetic result received from the arithmetic unit 6000 and outputs the thus obtained arithmetic result to the arithmetic unit 6002. The arithmetic unit 6002 performs an arithmetic operation using the arithmetic result received from the arithmetic unit 6001.

Suppose, for example, that the configuration of the logic circuit 4011 is altered during the series of arithmetic operations. More precisely, the configuration of the logic circuit 4011 is altered according to the reconfiguration information to configure another circuit, immediately after completion of the arithmetic operation by the arithmetic unit 6000 but before completion of the arithmetic operation by the arithmetic unit 6001. Thereafter, the configuration of the logic circuit 4011 is altered again to reconfigure the arithmetic units 6000, 6001, and 6002 within the logic circuit 4011. In such a case, it is preferable that the reconfigured arithmetic units 6000, 6001, and 6002 are able to use the arithmetic results of the arithmetic operations previously done, to avoid the waste of starting over all the arithmetic operations from the beginning. One way to achieve this is to save all the intermediate results of arithmetic operations by the arithmetic units 6000, 6001, and 6002. In addition, it is also necessary to save information indicating where the series of arithmetic operations by the respective arithmetic units needs to be resumed.

For the sake of simplicity, the logic circuit 4011 is described to include the three arithmetic units 6000, 6001, and 6002. It should be appreciated, however, that any number of arithmetic units may be configured within the logic circuit 4011.

In addition, the reconfiguration unit 1110 is provided with such a circuit as a wiring control circuit for altering the interconnections between arithmetic units. The logic circuit 4011 is configured by altering the interconnections between arithmetic units according to the reconfiguration information.

### (Status Management Unit 4002)

The status management unit 4002 generates a logic unit status signal 4001 indicative of the status of the logic unit 1111 and outputs the logic unit status signal 4001 to the status holding unit 1130. More specifically, the logic unit status signal 4001 is information including, for example, arithmetic results obtained by the respective arithmetic units and an indication of a specific arithmetic unit from which the series of arithmetic operations should be resumed.

### (Buffer Control Unit 4000)

The buffer control unit 4000 receives a buffer write access request signal 1221 from a buffer access request unit 1220, which will be described later. Upon receipt of the buffer write access request signal 1221, the buffer control unit 4000 stores data transferred via the bus unit 1005 to the buffer memory 4021 provided in the buffer unit 1112.

In addition, the buffer control unit 4000 receives a buffer read access request signal 1222 from the buffer access request unit 1220. Upon receipt of the buffer read access request signal 1222, the buffer control unit 4000 transfers data stored in the buffer memory 4021 provided in the buffer unit 1112 to the data transfer control unit 1200 via the bus unit 1005.

If the buffer memory 4021 provided in the buffer unit 1112 becomes empty as a result of transferring all the data stored therein, the buffer control unit 4000 outputs a buffer empty signal 4004 to the reconfiguration control unit 1120.

### (Buffer Memory 4021)

The buffer memory 4021 temporarily stores data, under control by the buffer control unit 4000.

### (2) Reconfiguration Control Unit 1120

The reconfiguration control unit 1120 controls the reconfiguration unit 1110 to configure one or more circuits.

The reconfiguration control unit 1120 receives the reconfiguration request signal 1211 from a memory bandwidth monitoring unit 1210. Upon receipt of the reconfiguration request signal 1211, the reconfiguration control unit 1120 reconfigures the reconfiguration unit 1110, based on the reconfiguration information 1212 and the information saved to the status holding unit 1130 at the time of the previous reconfiguration. At the same time, there configuration control unit 1120 outputs a reconfiguration implement signal 4003 to the status holding unit 1130.

The reconfiguration control unit 1120 receives the buffer empty signal 4004 during the time no reconfiguration request signal 1211 remains unprocessed and the memory bandwidth does not exceed a given threshold. In such a case, the reconfiguration control unit 1120 configures the logic unit 1111 into “Circuit A” based on the information saved in the status holding unit 1130. The logic unit 1111 in which “Circuit A” is present is the initial status before the buffer unit 1112 is configured.

### (3) Status Holding Unit 1130

The status holding unit 1130 has stored therein a status holding table 5000 for storing, at a time of dynamic alteration of the circuit configuration, the circuit status of the logic circuit 4011 before the alteration and intermediate arithmetic results.

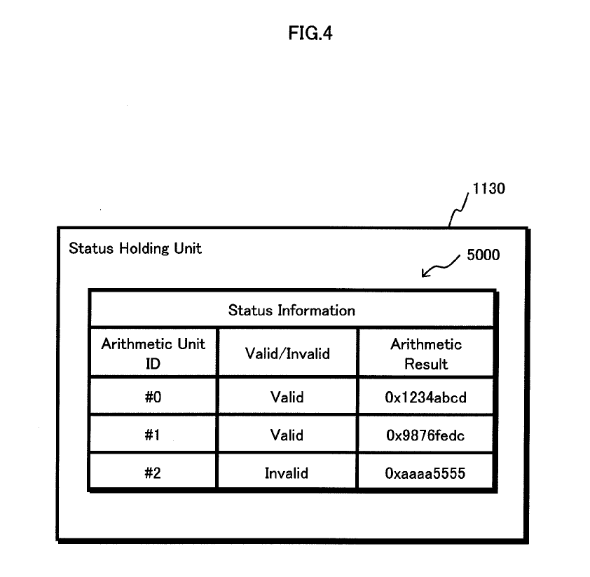

As shown in FIG. 4, the status holding table 5000 stores a plurality of pieces of status information. Each piece of status information corresponds to an arithmetic unit configured in the logic circuit 4011 and includes an arithmetic unit ID, a valid/invalid indication, and an arithmetic result. The arithmetic unit ID is identification information identifying a corresponding arithmetic unit. The valid/invalid indication indicates whether the corresponding arithmetic unit is valid or invalid. Here, an arithmetic unit is “valid” means that the arithmetic unit is currently functioning as part of the logic circuit 4011, where as an arithmetic unit is “invalid” means that the arithmetic unit is not currently functioning as part of the logic circuit 4011. The arithmetic result is a value obtained as a result of an arithmetic operation performed by the corresponding arithmetic unit.

As described above, the status holding unit 1130 stores, in addition to the status holding table 5000, information specifying one of the arithmetic units 6000, 6001, and 6002 from which the series of arithmetic operations is to be resumed. The above-described is an example of the information showing the status of the logic circuit 4011.

The status holding unit 1130 receives the reconfiguration implement signal 4003 from the reconfiguration control unit 1120 and the logic unit status signal 4001 from the status management unit 4002. Upon receipt of the reconfiguration implement signal 4003, the status holding unit 1130 acquires the current status of the logic unit 1111 and the intermediate arithmetic results from the logic unit status signal 4001 that is received from the status management unit 4002 and then stores the thus acquired status and arithmetic result into the status holding table 5000.

### 1.3 Data Transfer Control Unit 1200

The data transfer control unit 1200 arbitrates among a plurality of transfer requests output from the first and second bus master units 1000 and 1001 and access the data storage unit 1002 according to the result of arbitration. As shown in FIG. 1, the data transfer control unit 1200 includes the buffer access request unit 1220, the memory bandwidth monitoring unit 1210, and one or more other component units not shown in the figure.

### (1) Buffer Access Request Unit 1220

When the first bus master unit 1000 (or the second bus master unit 1001) accesses the data storage unit 1002, the buffer access request unit 1220 outputs the following requests to the buffer unit 1112. That is, (a) if data is requested to be stored to the buffer memory 4021 provided in the buffer unit 1112, the buffer access request unit 1220 outputs the buffer write access request signal 1221 indicating that a write access to the buffer memory 4021 is requested. On the other hand, (b) if data is requested be read from the buffer memory 4021 provided in the buffer unit 1112, the buffer access request unit 1220 outputs the buffer read access request signal 1222 indicating that a read access from the buffer memory 4021 is requested.

### (2) Memory Bandwidth Monitoring Unit 1210

The memory bandwidth monitoring unit 1210 monitors the usage condition of the memory bandwidth and outputs the reconfiguration request signal 1211 and the reconfiguration information 1212 to the reconfiguration control unit 1120. The reconfiguration request signal 1211 indicates that the reconfiguration is requested. The reconfiguration information 1212 is information necessary for performing the reconfiguration.

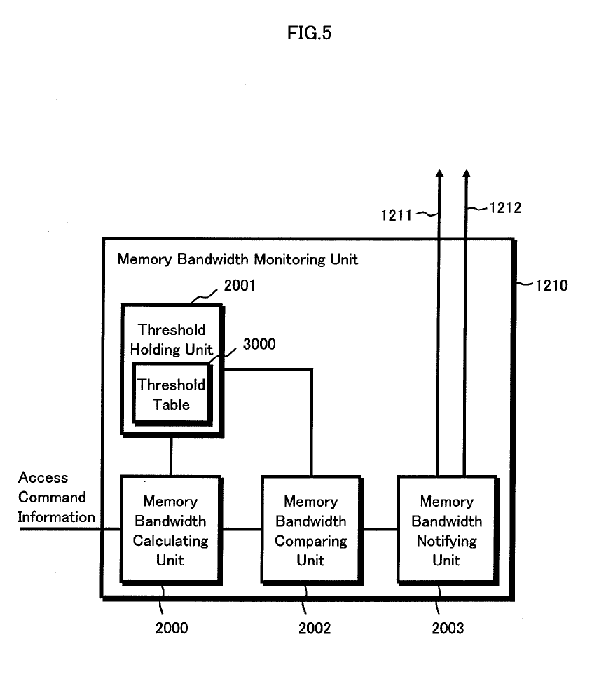

As shown in FIG. 5, the memory bandwidth monitoring unit 1210 includes a memory bandwidth calculating unit 2000, a threshold holding unit 2001, a memory bandwidth comparing unit 2002, and a memory bandwidth notifying unit 2003.

### (Memory Bandwidth Calculating Unit 2000)

The memory bandwidth calculating unit 2000 calculates the memory bandwidth based on access commands issued by the first bus master unit 1000 and the second bus master unit 1001 to the data storage unit 1002. Each access command includes information indicating the size of transfer data (or the number of data transfers). The memory bandwidth calculating unit 2000 calculates the total size of data to be transferred within a unit time based on information retrieved from each access command being granted to be executed as a result of arbitration by the data transfer control unit 1200, and determines the memory bandwidth to be equal to the thus calculated total data size. Next, the memory bandwidth calculating unit 2000 outputs the thus determined memory bandwidth to the memory bandwidth comparing unit 2002. When no access command is acquired such as during the time any access command is issued by neither of the first bus master unit 1000 and the second bus master unit 1001, the memory bandwidth is determined to be equal to “0”.

### (Threshold Holding Unit 2001)

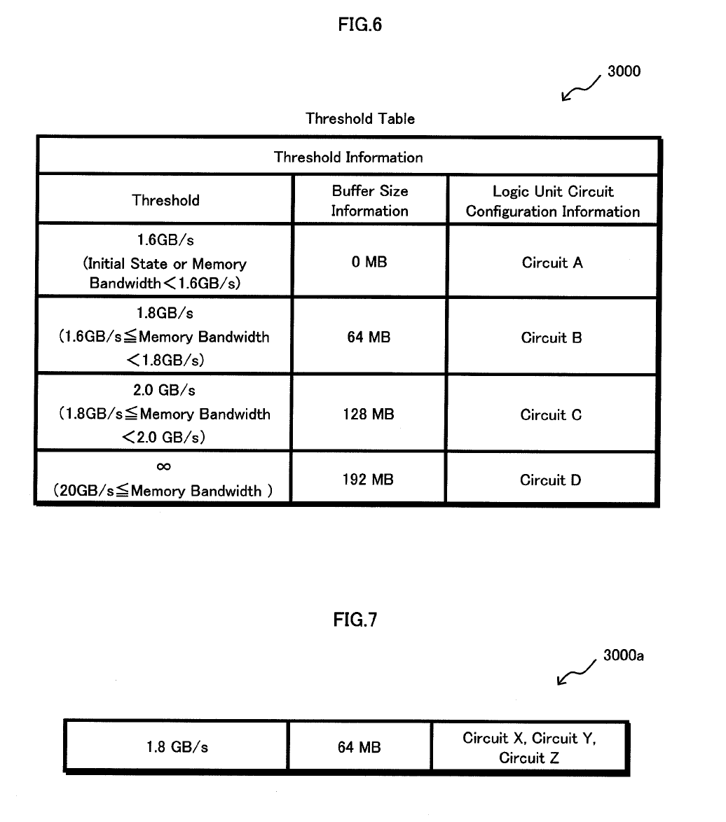

As shown in FIG. 6, the threshold holding unit 2001 has stored therein a threshold table 3000 that includes threshold information of the memory bandwidth.

The possible values of the memory bandwidth are divided into a plurality of ranges. For each memory bandwidth range, the threshold table 3000 defines a different circuit and a buffer of a different size to be configured, within the reconfiguration unit 1110, as the logic unit 1111 and the buffer unit 1112. The threshold table 3000 is used by the reconfiguration unit 1110 to determine a logic circuit configuration suitable to the memory bandwidth calculated by the memory bandwidth calculating unit 2000.

As shown in FIG. 6, the threshold table 3000 includes a plurality of pieces of threshold information corresponding in one-to-one with the memory bandwidth ranges. Each piece of threshold information includes a threshold, buffer size information, and logic circuit configuration information. The threshold indicates an upper limit of the corresponding range. The buffer size information indicates the size of the buffer unit 1112 to be configured in the reconfiguration unit 1110. The logic circuit configuration information indicates the circuit configuration the logic unit 1111 to be configured in the reconfiguration unit 1110.

In one specific example, the threshold table 3000 includes the following pieces of threshold information: a piece of threshold information including the threshold “1.6 GB/s”, the buffer size information “0 MB”, and the logic circuit configuration information “Circuit A”; a piece of threshold information including the threshold “1.8 GB/s”, the buffer size information “64 MB” and the logic circuit configuration information “Circuit B”; a piece of threshold information including the threshold information threshold “2.0 GB/s”, the buffer size information “128 MB” and the logic circuit configuration information “Circuit C”; a piece of threshold information including the threshold “8”, the buffer size “192 MB”, and the logic circuit configuration information “Circuit D”.

Note that the logic circuit configuration information “Circuit A” includes circuit configuration information for configuring, within the reconfiguration unit 1110, the buffer control unit 4000 and the logic unit 1111 that includes the status management unit 4002, the arithmetic data request unit 4005, and the logic circuit 4011. The logic circuit 4011 comprises either or both of an arithmetic unit and a control unit.

Similarly, the pieces of logic circuit configuration information “Circuit B”, “circuit C” and “circuit D” each include circuit configuration information for configuring the logic circuit 4011 within the reconfiguration unit. According to the pieces of logic circuit configuration information “Circuit B”, “circuit C” and “circuit D”, the status management unit 4002, the arithmetic data request unit 4005 and the logic circuit 4011 are left as they are without being reconfigured. In addition, the logic circuit 4011 comprises either or both of an arithmetic unit and a control unit.

The exemplary threshold table 3000 shown in FIG. 6 means the following. That is, when the consumer appliance 10 is powered ON or reset or when the calculated memory bandwidth is less than 1.6 GB/s, the reconfiguration unit 1110 is without the buffer unit 1112 and the logic unit 1111 has the configuration according to Circuit A. When the calculated memory bandwidth is equal to or greater than 1.6 GB/s but less than 1.8 GB/s, the reconfiguration unit 1110 configures the buffer unit 1112 having the size of 64 MB and the logic unit 1111 having the configuration according to Circuit B. When the calculated memory bandwidth is equal to or greater than 1.8 GB/s but less than 2.0 GB/s, the reconfiguration unit 1110 configures the buffer unit 1112 having the size of 128 MB and the logic unit 1111 having the configuration according to Circuit C. When the calculated memory bandwidth is equal to or greater than 2.0 GB/s, the reconfiguration unit 1110 configures the buffer unit 1112 having the size of 192 MB and the logic unit 1111 having the configuration according to Circuit D.

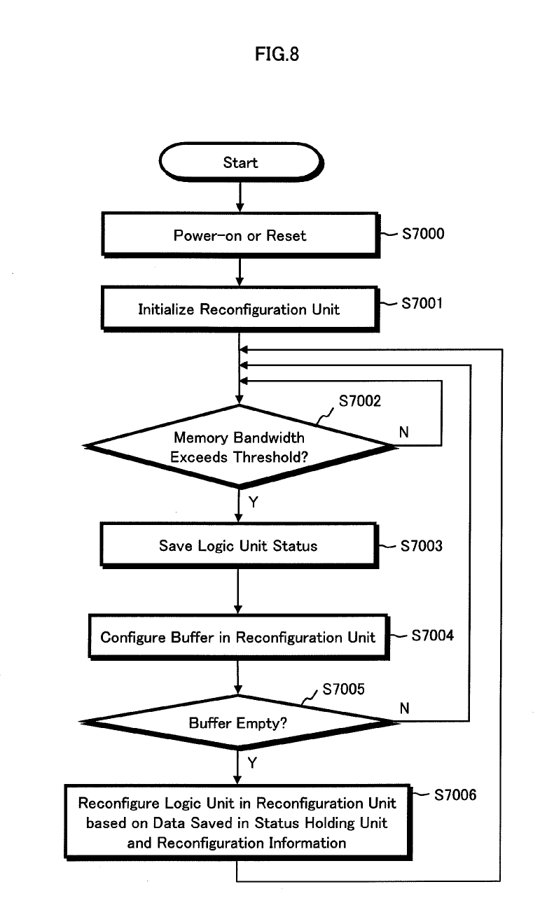

In the above description, the threshold table 3000 shown in FIG. 6 is such that one threshold corresponds to one circuit. However, one threshold range in the threshold table may be associated with a plurality of circuits. In that case, each time reconfiguration is performed, the plurality of circuits are configured and one of the circuits is selectively used. As one specific example, FIG. 7 shows the threshold table 3000 containing a piece of threshold information 3000a that includes the threshold “1.8 GB/s”, the buffer size information “64 MB”, and logic circuit configuration information indicating “Circuit X, Circuit Y, and Circuit Z”. This piece of threshold information 3000a indicates that when the calculated memory bandwidth is equal to or greater than 1.6 GB/s but less than 1.8 GB/s, the buffer unit 1112 having the size of 64 MB is configured and the logic circuit 1111 having all of Circuits X, Y, and Z is configured.

In the above description, in addition, the threshold table 3000 shown in FIG. 6 includes four pieces of threshold information. However, this is merely for purposes of simplicity in the explanation and any number of pieces of threshold information may be stored. For example, the threshold table 3000 may store two or three pieces of threshold information or more pieces of threshold information. The threshold information may be set in advance at design time of the semiconductor integrated circuit or may be alterable by software.

### (Memory Bandwidth Comparing Unit 2002)

The memory bandwidth comparing unit 2002 receives the memory bandwidth from the memory bandwidth calculating unit 2000 and reads all the pieces of threshold information from the threshold table 3000 stored in the threshold holding unit 2001. Then, as described above, the memory bandwidth comparing unit 2002 compares the memory bandwidth calculated by the memory bandwidth calculating unit 2000 with the thresholds held in the threshold holding unit 2001 and outputs the result of comparison to the memory bandwidth notifying unit 2003.

### (Memory Bandwidth Notifying Unit 2003)

The memory bandwidth notifying unit 2003 receives the comparison result from the memory bandwidth comparing unit 2002. In the case where the comparison result indicates that the memory bandwidth calculated by the memory bandwidth calculating unit 2000 is greater than a specific one of the thresholds of the memory bandwidth held in the threshold holding unit 2001, it is then judged whether the current configuration of the buffer unit 1112 and the logic unit 1111 is the same as the configuration indicated by the piece of buffer size information and logic circuit configuration information corresponding to the specific threshold of memory bandwidth indicated in the comparison result. If the configuration is different, the memory bandwidth notifying unit 2003 generates the reconfiguration information 1212 from the corresponding piece of buffer size information and logic circuit configuration information and outputs the reconfiguration request signal 1211 and the reconfiguration information 1212 to the reconfiguration control unit 1120. On the other hand, if the configuration shown by the corresponding piece of buffer size information and logic circuit configuration information is the same as the current configuration of the buffer unit 1112 and the logic unit 1111, no reconfiguration is required.

### 2. Operation of Consumer Appliance 10

The following describes operation of the consumer appliance 10.

### (1) Overview of Operation of Semiconductor Integrated Circuit 100

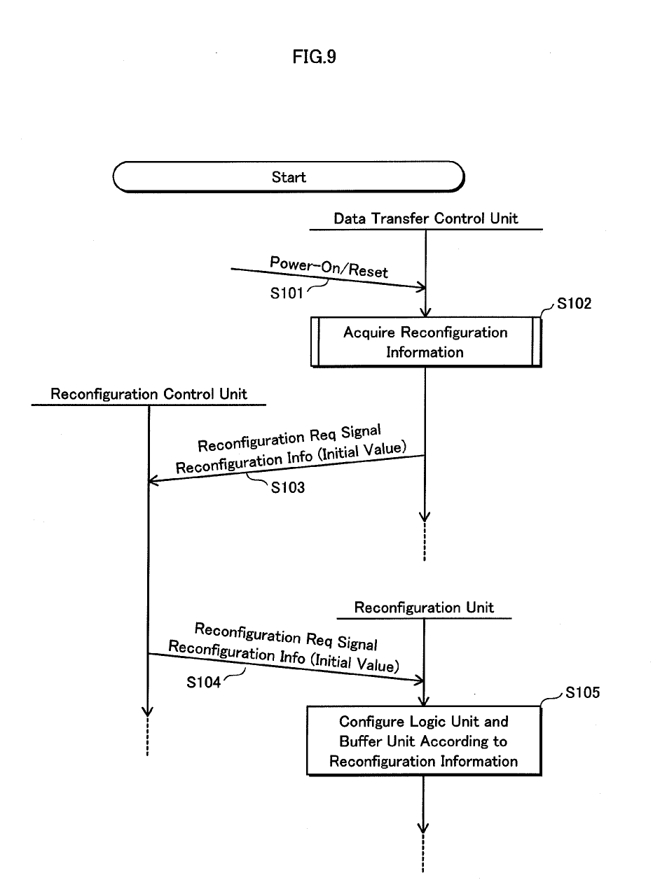

The following describes the overview of operation of the semiconductor integrated circuit 100, with reference to a flowchart shown in FIG. 8.

At poser-ON or reset (Step S7000), the reconfiguration unit 1110 in the semiconductor integrated circuit 100 configures the initial status (Step S7001).

Next, the memory bandwidth comparing unit 2002 judges whether the calculated memory bandwidth exceeds a threshold (Step S7002). If the threshold is not exceeded (Step S7002: NO), the processing goes back to Step S7002 to repeat the comparison process with the next threshold.

If the threshold is exceeded (Step S7002: YES), the status holding unit 1130 acquires, in response to the reconfiguration implement signal 4003, the current status of the reconfiguration unit 1110 (i.e., the status before the subsequent reconfiguration) from the logic unit status signal 4001 and saves the acquired status (Step S7003). Next, the reconfiguration control unit 1120 causes the logic circuit 4011 to be configured in the logic unit 1111 and the buffer memory 4021 in the buffer unit 1112 (Step S7004).

If the buffer control unit 4000 outputs no buffer empty signal 4004 to the reconfiguration control unit 1120 (Step S7005: NO), the processing goes back to Step S7002 to repeat the subsequent steps.

If the buffer empty signal 4004 is output (Step S7005: YES), the configuration of the logic unit 1111 is altered based on the information saved in the status holding unit 1130 so as to restore the status of the logic unit 1111 as it was before the buffer unit 1112 was configured (Step S7006).

Next, the processing goes back to Step S7002 to repeat the subsequent steps.

### (2) Details of Operation of Semiconductor Integrated Circuit 100

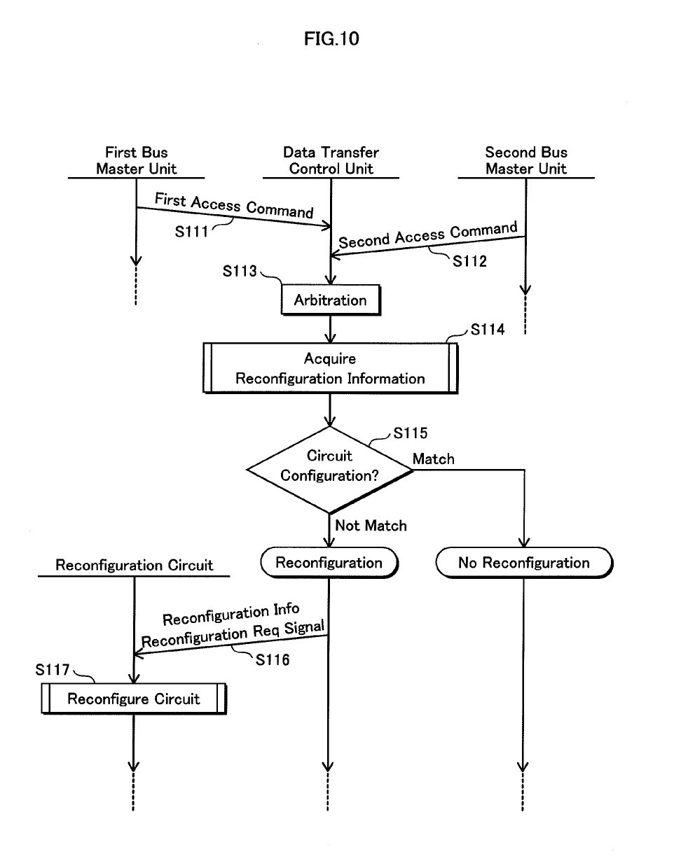

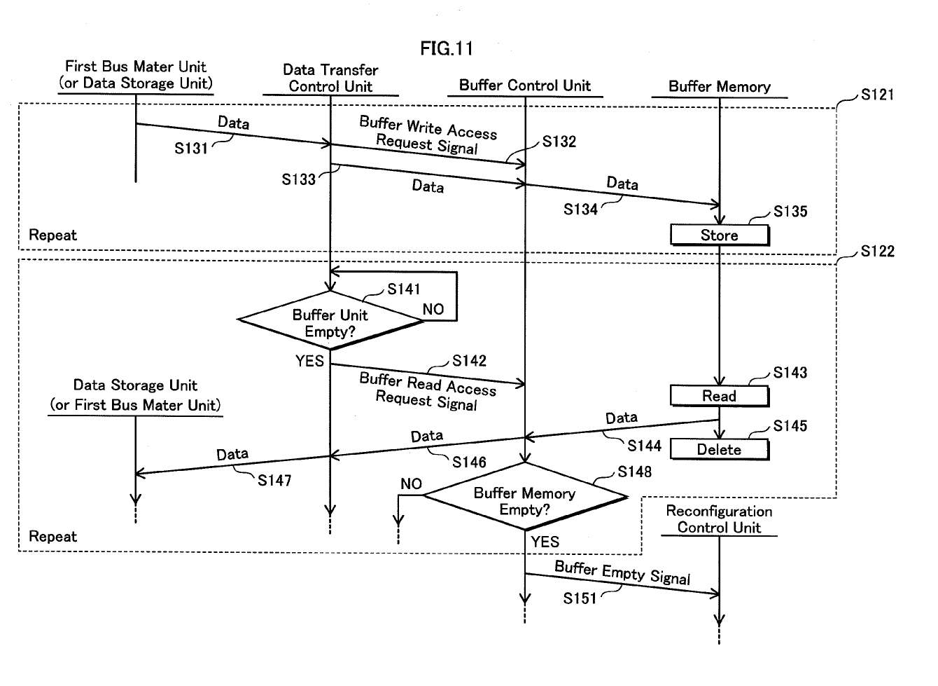

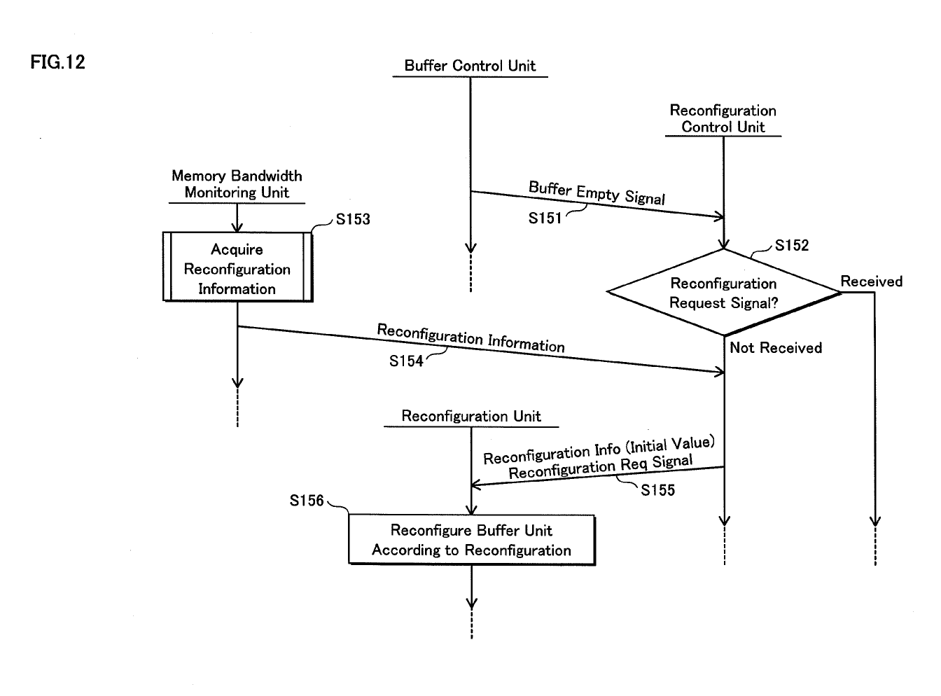

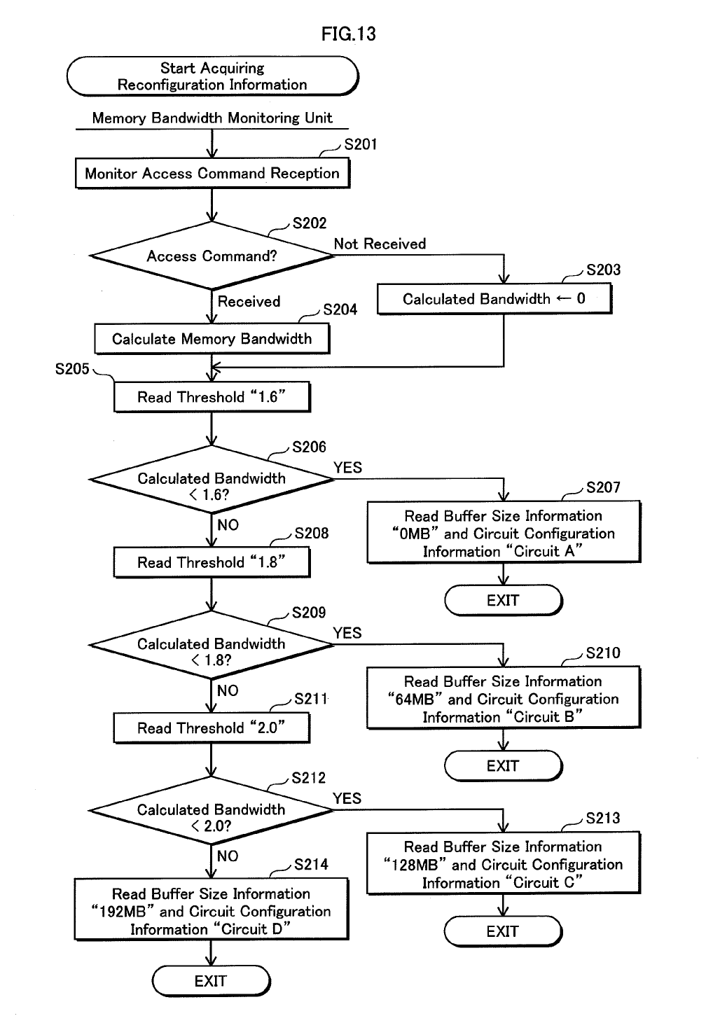

The following is a detailed description of the operation of the semiconductor integrated circuit 100, with reference to the flowchart shown in FIGS. 9-12.

At power-ON or reset (Step S101), the data transfer control unit 1200 acquires the reconfiguration information (Step S102). Being acquired immediately after the power-ON or reset, this reconfiguration information is of an initial value. The step of acquiring reconfiguration information will be described later in detail. Next, the data transfer control unit 1200 outputs the reconfiguration request signal and the acquired reconfiguration information (initial value) to the reconfiguration control unit 1120 (Step S103). Next, the reconfiguration control unit 1120 outputs the reconfiguration request signal and the reconfiguration information (initial value) to the reconfiguration unit 1110. The reconfiguration unit 1110 configures the logic unit 1111 and the buffer unit 1112 according to the received reconfiguration information (Step S105).

The description up to this point relates to the initialization of the reconfiguration unit 1110 of the semiconductor integrated circuit 100 and this processing corresponds to Steps S7000-S7001 of FIG. 8.

Next, the first bus master unit 1000 outputs a first access command to the data transfer control unit 1200. The first access command instructs to transfer data to the data storage unit 1002 and includes the total size of data to be transferred (Step S111). In addition, the second bus master unit 1001 outputs a second access command to the data transfer control unit 1200. The second access command instructs to transfer data to the data storage unit 1002 and includes the total size of data to be transferred (Step S112). For purposes of deception, it is supposed the first access command by the first bus master unit 1000 and the second access command by the second bus master unit 1001 are output at about the same time. It is also supposed that the first access command issued by the first bus master unit 1000 is assigned with a priority level higher than the priority level assigned to the second access command issued by the second bus master unit 1001.

If the data transfer control unit 1200 receives both the first and second access commands respectively from the first and second bus master units 1000 and 1001, an arbiter unit (not illustrated) provided in the data transfer control unit 1200 arbitrates between the first and second access commands. The arbitration is carried out according to the priority levels assigned to the respective access commands. Since the first access command has a higher priority level than that of the second access command, the first access command is executed in priority to the second access command (Step S113).

Next, the data transfer control unit 1200 acquires the reconfiguration information (Step S114). The step of acquiring the reconfiguration information will be described later.

The data transfer control unit 1200 compares the current configuration of the reconfiguration unit 1110 with the acquired reconfiguration information in the following manner. For example, the data transfer control unit 1200 stores an identifier identifying the piece of reconfiguration information previously acquired and used for reconfiguration and compares the previously stored identifier with the identifier of the reconfiguration information acquired this time. For the subsequent comparison of the configuration, the data transfer control unit 1200 newly stores the identifier of the currently acquired reconfiguration information (Step S115). If the previously stored configuration information matches the current configuration (Step S115: “Match”), no reconfiguration takes place.

On the other hand, if the previously stored configuration information does not match the current configuration (Step S115: “Not Match”), the data transfer control unit 1200 outputs the acquired reconfiguration information to the reconfiguration circuit 1100, along with the reconfiguration request signal (Step S116). The reconfiguration circuit 1100 configures the logic unit 1111 and the buffer unit 1112 within the reconfiguration unit 1110 (Step S117).

The steps up to this point complete the reconfiguration of the reconfiguration unit 1110 in the reconfiguration circuit 1100.

The following now describes data transfer from the first bus master unit 1000 (or the data storage unit 1002) to the data storage unit 1002 (or the first bus master unit 1000), and vice versa. In the following description of operation of the semiconductor integrated circuit 100 still holds, even if the term “the first bus master unit 1000” is replaced with “the second bus master unit 1001”.

The first bus master unit 1000 (or the data storage unit 1002) outputs, to the data transfer control unit 1200, a portion of the transfer data that corresponds in amount to a portion of the memory bandwidth exceeding the threshold (Step S131). The data transfer control unit 1200 outputs a buffer write access request signal to the buffer control unit 4000 (Step S132) and also outputs the transfer data to the buffer control unit 4000 (Step S133). Next, the buffer control unit 4000 outputs the transfer data to the buffer memory 4021 (Step S134) and the buffer memory 4021 stores the transfer data (Step S135).

If the portion of the transfer data corresponding to the exceeding portion of the memory bandwidth is larger than the maximum amount of data that can be transferred at a time from the first bus master unit 1000 to the data storage unit 1002 (or from the data storage unit 1002 to the first bus master unit 1000) through Steps S131-S135, Steps S131-S135 are repeated as long as there remains any data to be transferred.

The data transfer control unit 1200 monitors the usage condition of the bus unit 1005. Upon detecting that the bus unit 1005 is empty, i.e., that the bus unit 1005 stores no data to be transferred (Step S141: YES), the data transfer control unit 1200 outputs a buffer read access request signal to the buffer control unit 4000 (Step S142). Under control by the buffer control unit 4000, the buffer memory 4021 reads data (Step S143) and outputs the read data to the buffer control unit 4000, and deletes the read data from the buffer memory 4021 (Step S145). The buffer control unit 4000 outputs the read data to the data transfer control unit 1200 (Step S146). The data transfer control unit 1200 outputs the read data to the data storage unit 1002 (or the first bus master unit 1000) (Step S147).

The buffer control unit 4000 monitors whether the buffer memory 4021 is empty or not (Step S148).

In the case where the amount of data stored in the buffer memory 4021 exceeds the maximum amount of data that can be transferred at a time by executing Steps S142-S148, Steps S142-S148 are repeated as long as data to be transmitted remains in the buffer memory 4021.

Through the above steps, the data transfer from the first bus master unit 1000 to the data storage unit 1002 completes.

Next, when the buffer control unit 4000 detects that the buffer memory 4021 is empty (Step S148: YES), the buffer control unit 4000 outputs a buffer empty signal to the reconfiguration control unit 1120 (Step S151).

Upon receipt of the buffer empty signal (Step S151), the reconfiguration control unit 1120 judges whether a reconfiguration request signal has been received or not (Step S152). If a reconfiguration request signal has been received, the reconfiguration control unit 1120 operates according to the request.

The memory bandwidth monitoring unit 1210 acquires the reconfiguration information. The step of acquiring the reconfiguration information will be described later in detail. At this point in time, if there is no access command received from the first bus master unit 1000 or the second bus master unit 1001, the reconfiguration information is acquired with the initial value (Step S153). The memory bandwidth monitoring unit 1210 outputs the acquired reconfiguration information to the reconfiguration control unit 1120 (Step S154).

If no reconfiguration request signal is received (Step S152: “Not Received”) but the reconfiguration information (initial value) is received from the memory bandwidth monitoring unit 1210 (Step S154), the reconfiguration control unit 1120 outputs the reconfiguration information (initial value) and the reconfiguration request signal to the reconfiguration unit 1110 (Step S155). The reconfiguration unit 1110 configures the logic unit 1111 and the buffer unit 1112 according to the reconfiguration information (initial value), so that the reconfiguration unit 1110 is initialized (Step S156).

### (3) Acquisition of Reconfiguration Information by Memory Bandwidth Monitoring Unit 1210

The following now describes the step of acquiring reconfiguration information by the memory bandwidth monitoring unit 1210, with reference to a flowchart shown in FIG. 13.

The memory bandwidth monitoring unit 1210 monitors every access command granted as a result of arbitration by the arbiter unit included in the data transfer control unit 1200 (Step S201). If any access command is granted (Step S202: “Received”), the memory bandwidth monitoring unit 1210 extracts, from the granted access command, the total size of data to be transferred and calculates the memory bandwidth as being equal to the extracted total size (Step S204). If there is no pending access command as in, for example, a time period during which no access command is issued from either of the first bus master unit 1000 and the second bus master unit 1001 (Step S202 “Not Received”), the memory bandwidth is determined to be equal to “0” (Step S203).

Next, the memory bandwidth monitoring unit 1210 retrieves the threshold “1.6 GB/s” from the first piece of threshold information contained in the threshold table 3000 (Step S205), and compares the calculated memory bandwidth with the threshold “1.6 GB/s” (Step S206). If the calculated memory bandwidth is smaller than the threshold “1.6 GB/s” (Step S206: YES), the memory bandwidth monitoring unit 1210 retrieves, from the piece of threshold information corresponding to the threshold “1.6 GB/s”, the buffer size information “0 MB” and the logic circuit configuration information “Circuit A” to generate the reconfiguration information (Step S207). This completes the processing by the memory bandwidth monitoring unit 1210.

If the calculated memory bandwidth is equal to or greater than the threshold “1.6 GB/s” (Step S206: NO), the memory bandwidth monitoring unit 1210 retrieves the threshold “1.8 GB/s” from the next piece of threshold information contained in the threshold table 3000 (Step S208), and compares the calculated memory bandwidth with the threshold “1.8 GB/s” (Step S209). If the calculated memory bandwidth is smaller than the threshold “1.8 GB/s” (Step S209: YES), the memory bandwidth monitoring unit 1210 retrieves, from the piece of threshold information corresponding to the threshold “1.8 GB/s”, the buffer size information “64 MB” and the logic circuit configuration information “Circuit B” to generate the reconfiguration information (Step S210). This completes the processing by the memory bandwidth monitoring unit 1210.

If the calculated memory bandwidth is equal to or greater than the threshold “1.8 GB/s” (Step S209: NO), the memory bandwidth monitoring unit 1210 retrieves the threshold “2.0 GB/s” from the next piece of threshold information contained in the threshold table 3000 (Step S211) and compares the calculated memory bandwidth with the threshold “2.0 GB/s” (Step S212). If the calculated memory bandwidth is smaller than the threshold “2.0 GB/s” (Step S212: YES), the memory bandwidth monitoring unit 1210 retrieves, from the piece of threshold information corresponding to the threshold “2.0 GB/s”, the buffer size information “128 MB ” and the logic circuit configuration information “Circuit C” to generate reconfiguration information (Step S213). This completes the processing by the memory bandwidth monitoring unit 1210.

If the calculated memory bandwidth is equal to or greater than the threshold “2.0 GB/s” (Step S212: NO), the memory bandwidth monitoring unit 1210 retrieves, from the next piece of threshold information, the buffer size information “192 MB” and the logic circuit configuration information “Circuit D” to generate the reconfiguration information (Step S214). This completes the processing by the memory bandwidth monitoring unit 1210.

### (4) Reconfiguration by Reconfiguration Circuit 1100

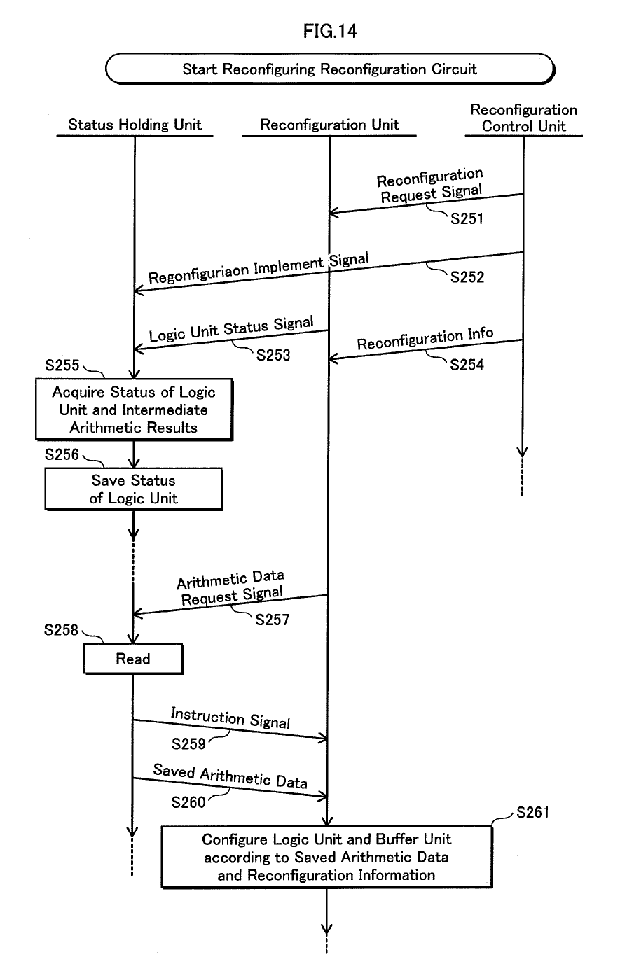

The following now describes the reconfiguring operation by the reconfiguration circuit 1100, with reference to a flowchart shown in FIG. 14.

Upon receipt of a reconfiguration instruction from the data transfer control unit 1200, the reconfiguration control unit 1120 outputs a reconfiguration request signal to the reconfiguration unit 1110 (Step S251), outputs a reconfiguration implement signal to the status holding unit 1130 (Step S252), and outputs the reconfiguration information to the reconfiguration unit 1110 (Step S254).

Upon receipt of the reconfiguration request signal (Step S251), the reconfiguration unit 1110 outputs the logic unit status signal to the status holding unit 1130 (Step S253). The status holding unit 1130 acquires the current status of the logic unit 1111 and an intermediate arithmetic result (Step S255) and saves the status of the logic unit 1111 along with the intermediate arithmetic result (Step S256).

Next, the reconfiguration unit 1110 outputs an arithmetic data request signal to the status holding unit 1130 (Step S257). In response, the status holding unit 1130 reads the status of the logic unit 1111 and the intermediate arithmetic result both previously saved (Step S258), outputs an instruction signal to the reconfiguration unit 1110 (Step S259), and outputs to the reconfiguration unit 1110 the status of the logic unit 1111 and the saved arithmetic data that is composed of the intermediate arithmetic result read in Step S258 (Step S260). In response, the reconfiguration unit 1110 configures the logic unit 1111 and the buffer unit 1112 in the reconfiguration unit 1110 according to the received reconfiguration information and the saved arithmetic data (Step S261).

### (5) Operation of Semiconductor Integrated Circuit 100

The following briefly describes the operation flow of the semiconductor integrated circuit 100 according to this embodiment.

At power-ON or reset, the reconfiguration control unit 1120 causes the initial state circuit to be configured in the logic unit 1111 and the buffer unit 1112.

In response to a data transfer request command issued to the data storage unit 1002 by the respective bus master units, including the first bus master unit 1000, the memory bandwidth comparing unit 2002 compares the memory bandwidth calculated by the memory bandwidth calculating unit 2000 and one of the thresholds held in the threshold holding unit 2001.

If the comparison shows that the calculated memory bandwidth exceeds the threshold, the memory bandwidth notifying unit 2003 outputs the reconfiguration request signal 1211 and the reconfiguration information 1212 to the reconfiguration control unit 1120.

Upon receipt of the reconfiguration request signal 1211 and the reconfiguration information 1212, the reconfiguration control unit 1120 outputs the reconfiguration implement signal 4003 to the status holding unit 1130, based on the reconfiguration request signal 1211. Upon receipt of the reconfiguration implement signal 4003, the status holding unit 1130 acquires the current status of the logic unit 1111 from the logic unit status signal 4001 and saves the acquired status. The status of the logic unit 1111 acquired herein is information indicating, in a manner similar to the status holding table 5000, the status of each arithmetic unit and arithmetic results of the respective arithmetic units.

The reconfiguration control unit 1120 reconfigures the logic unit 1111 and the buffer unit 1112 in the reconfiguration unit 1110 according to the reconfiguration information 1212 and the information stored at the time of previous reconfiguration to the status holding unit 1130.

Upon receipt of the buffer write access request signal 1221, the buffer control unit 4000 stores to the buffer unit 1112 a portion of the transfer data corresponding in amount to the memory bandwidth exceeding the threshold.

When the bus unit 1005 becomes empty, the buffer access request unit 1220 outputs the buffer read access request signal 1222. In response, data stored in the buffer unit 1112 is transferred to the data transfer control unit 1200 via the bus unit 1005, and then to the data storage unit 1002 via the bus unit 1006.

Further, in the case where the threshold table 3000 contains a plurality of pieces of threshold information, if the memory bandwidth exceeds a given threshold, the circuit configuration is altered to provide the buffer unit 1112 according to a corresponding piece of threshold information contained in the threshold table 3000. If the memory bandwidth exceeds another threshold during data transfer performed with the use of the thus configured buffer unit 1112, the circuit configuration is altered according to a corresponding piece of threshold information contained in the threshold table 3000.

When all the data stored in the buffer unit 1112 is transferred and thus the buffer unit 1112 becomes empty, the buffer control unit 4000 outputs a buffer empty signal 4004 to the reconfiguration control unit 1120. Suppose, on the other hand, that no reconfiguration request signal 1211 is output and the memory bandwidth does not exceed a given threshold. In such a case, upon receipt of the buffer empty signal 4004, the reconfiguration control unit 1120 reconfigures the logic unit 1111 by altering the circuit configuration back to the initial state where the buffer unit 1112 is not yet configured, based on information held in the status holding unit 1130 and resumes the series of arithmetic operations having been suspended.

### (6) Example of Transition in System Operation of Reconfiguration Unit 1110

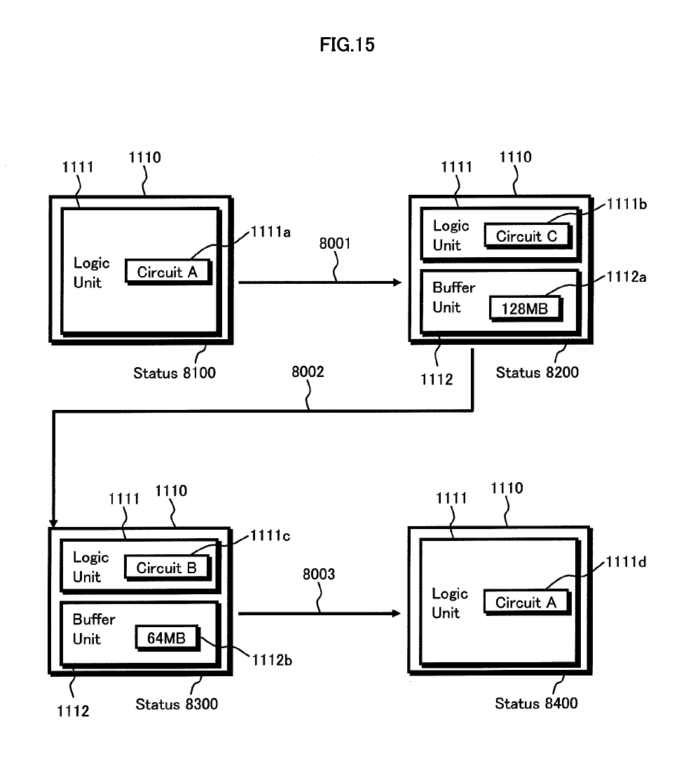

The following now describes an example of a transition in the system operation of the reconfiguration unit 1110 with reference to FIG. 15.

After being initialized in response to a power-ON or reset, the reconfiguration unit 1110 configures only “Circuit A” (1111a) in the logic unit 1111 according to the threshold table 3000 (Status 8100).

Suppose that the memory bandwidth thereafter exceeds 1.8 GB/s. Consequently, the reconfiguration unit 1110 configures Circuit C (1111b) in the logic unit 1111 and also configures the buffer unit 1112 having a size of 128 MB. The buffer unit 1112 includes a buffer memory 1112a. At this time, if Circuit A is in the middle of the arithmetic operation, the circuit status and the intermediate arithmetic result are saved to the status holding unit 1130 (Status 8200).

Suppose that the memory bandwidth thereafter becomes smaller than 1.8 GB/s but still exceeds 1.6 GB/s. Consequently, the reconfiguration unit 1110 configures Circuit B (1111c) in the logic unit 1111 and also configures the buffer unit 1112 having a size of 64 MB. The buffer unit 1112 includes the buffer memory 1112b. If necessary for the reconfiguration control unit 1120 to configure Circuit B (1111c) in the logic unit 1111, information saved in the status holding unit 1130 is applied to Circuit B (1111c). In addition, if Circuit C (1111b) is in the middle of the arithmetic operation, the circuit status and the intermediate arithmetic result are saved to the status holding unit 1130 (Status 8300).

Suppose that the memory bandwidth thereafter becomes smaller than 1.6 GB/s. In addition, all the data stored to the buffer unit 1112 in the status 8200 or 8300 is transferred to the data storage unit 1002, so that the buffer unit 1112 becomes empty. Consequently, the reconfiguration unit 1110 configures only Circuit A (1111d) in the logic unit 1111 (status 8400).

### 3. Recapitulation

As has been described above, the present embodiment enables the reconfiguration unit 1110 to configure the buffer unit 1112 in the case where the memory bandwidth of each bus master unit may exceed the device-dependent maximum memory bandwidth of the data storage unit 1002. The thus configured buffer unit 1112 accommodates an amount of data corresponding to the exceeded memory bandwidth. As a result, the necessary memory bandwidth dully reserved.

Note that during execution of DMA (direct memory access) by the logic unit 1111, the memory bandwidth may exceed a given threshold. In such a case, the present embodiment ensures to configure that the buffer unit 1112 having an area for temporarily storing the transfer data related to the DMA and allowing the logic unit 1111 to access the buffer unit 1112. With this arrangement, failure of the system is duly prevented.

### 4. Other Modifications

1) According to the above embodiment, each bus master unit accesses the data storage unit 1002. However, the present invention is not limited to such.

The semiconductor integrated circuit 100 may be provided with a third bus master unit (may also referred to as a “fourth device”) in place of the data storage unit 1002. The first bus master unit 1000 may perform data transfer with the third bus master unit rather than with the data storage unit 1002. Similarly, the second bus master unit 1001 may perform data transfer with the bus master unit rather than with the data storage unit 1002.

At this time, for example, data transfer between the first bus master unit 1000 and the third bus master unit is to be performed in priority to data transfer between the second bus master unit 1001 and the third bus master unit. The data transfer control unit 1200 arbitrates between the two data transfer processes to prioritize the data transfer between the first bus master unit 1000 and the third bus master unit. The memory bandwidth monitoring unit 1210 calculates the memory bandwidth from an access command output from the first bus master unit 1000 and compares the calculated memory bandwidth with a given threshold to judge whether or not to reconfigure the reconfiguration unit 1110. On determination to perform the reconfiguration, the memory bandwidth monitoring unit 1210 outputs the reconfiguration information to the reconfiguration control unit 1120 and the reconfiguration unit 1110 reconfigures the circuit according to the reconfiguration information.

(2) The threshold table 3000 shown in FIG. 6 may be modified to contain, instead of the piece of threshold information including the threshold “2.0 GB/s”, the buffer size information “128 MB”, and the logic circuit configuration information “Circuit C”, a piece of threshold information including the threshold “2.0 GB/s” and the buffer size information “256 MB”. This piece of threshold information includes no logic circuit configuration information. According to such a piece of threshold information, the buffer memory 4021 having a size of 256 MB is configured but the logic circuit 4011 is not configured.

(3) It is applicable to omit the status holding unit 1130 from the reconfiguration circuit 1100 shown in FIG. 1. In addition, the status management unit 4002 and the arithmetic data request unit 4005 may be omitted as well. In such a case, however, the information indicating the circuit configuration of the previously configured logic circuit 4011 cannot be used by the reconfiguration unit 1110 to reconfigure the logic circuit 4011 having the same circuit configuration.

(4) According to the above embodiment, the data transfer control unit 1200 shown in FIG. 1 includes an arbiter unit (not shown in the figure), the buffer access request unit 1220, and the memory bandwidth monitoring unit 1210. Alternatively, however, the data transfer control unit 1200 may be modified as follows.

The transfer control unit 1200 is without any of the arbiter unit, the buffer access request unit 1220, and the memory bandwidth monitoring unit 1210. Instead, the transfer control unit 1200 per se is configured to be able to execute the functionalities of the arbiter unit, the buffer access request unit 1220, and the memory bandwidth monitoring unit 1210.

(5) According to the present invention, the following is achieved. Suppose that a bus master is required to respond in real-time and thus assigned with a higher priority level with respect to an access request to a data storage unit. The bus master unit includes an arithmetic unit and/or a control unit that only uses a portion of the memory bandwidth remaining unused during the time no access request to the data storage unit by the bus master unit is being executed. If the arithmetic unit and/or the control unit is being an excess unit, a reconfiguration circuit allows the excess unit to be used as a buffer. In this manner, the present invention provides a data transfer device, a data transfer method, and a semiconductor integrated circuit each of which ensures, with the above-described reconfiguration circuit, the effective use of bandwidth at low cost.

The present invention is directed to a technique for transferring, within in a semiconductor integrated circuit, data between a bus master and memory via a bus. The semiconductor integrated circuit has a plurality of bus masters, a plurality of buses, and a memory. The present invention in particular relates to a technique for improving data transfer with the use of a reconfiguration circuit to effectively reserve the memory bandwidth required by the respective bus masters.

A semiconductor integrated circuit includes: a data storage unit for storing data to be transferred; a plurality of bus master units each for accessing the data storage unit; a data transfer control unit for managing data transfer requests individually issued by the respective bus master units and for accessing the data storage unit; a plurality of bus units A each connecting a different one of the bus master units to the data transfer control unit; and a bus unit B connecting the data transfer control unit with the data storage unit. Each of the plurality of bus master units performs data transfer via a corresponding one of the bus units A, the data transfer control unit, and the bus unit B. The semiconductor integrated circuit further includes a memory bandwidth monitoring unit, a reconfiguration unit, and a reconfiguration control unit. The memory bandwidth monitoring unit monitors the memory bandwidth required by each of the bus master units to access the data storage unit via a corresponding one of the bus units A, the data transfer control unit, and the bus unit B. The reconfiguration unit is connected to the data transfer control unit with bus-connection similarly to the plurality of bus master units. The reconfiguration control unit controls the reconfiguration unit based on output information received from the memory bandwidth monitoring unit.

This structure enables to judge whether the memory bandwidth reaches a predetermined value and optimally control the reconfiguration unit depending on the judgment result.

Regarding the semiconductor integrated circuit stated above, the following is further noted. That is, when the memory bandwidth monitoring unit judges that the predetermined value is reached by the memory bandwidth required by the plurality of bus master unit to access the data storage unit via the respective bus units A, the data transfer control unit and the bus unit B, the reconfiguration control unit reconfigures the reconfiguration unit into a predetermined circuit configuration.

Regarding the semiconductor integrated circuit stated above, the following is further noted. That is, when the required memory bandwidth monitoring unit judges that the memory bandwidth is smaller than a given threshold, the logic unit is reconfigured into an arithmetic unit or a control unit. When the required memory bandwidth is judged to be larger, the reconfiguration unit is reconfigured into a buffer unit for temporarily storing data to be later stored to or read from the data storage unit by the plurality of bus master units. Note that the given threshold is a limit for judging that a portion of the available memory bandwidth remains unused. The semiconductor integrated circuit further includes a status holding unit for holding the processing status of the logic unit immediately before the reconfiguration unit configuring the buffer unit.

Regarding the semiconductor integrated circuit stated above, the following is further noted. That is, an access to the data storage unit by a bus master unit that is required to respond in real-time may be assigned with a higher priority level. During the time no access request to the data storage unit by such a higher-priority the bus master unit is being executed, a portion of the available memory bandwidth may remain unused. In such a case, the logic unit is reconfigured into an arithmetic unit or a control unit each of which act as a bus master unit that only uses the unused portion of the memory bandwidth.

Regarding the semiconductor integrated circuit stated above, the following is further noted. That is, when the memory bandwidth monitoring unit judges that the required memory bandwidth is smaller than a given threshold, the reconfiguration control unit configures the logic unit acting as an arithmetic unit or a control unit. When the required memory bandwidth is judged to be larger then the threshold, the reconfiguration unit may configure, in addition to the logic unit, a buffer unit for temporarily storing data accessed to or from the data storage unit by the plurality of bus master unit. Note that the given threshold is a limit for judging that a portion of the available memory bandwidth is remains unused.

The semiconductor integrated circuit stated above may further include a status holding unit for storing the processing status of the logic unit immediately before the reconfiguration by the reconfiguration unit tales place to configure the buffer unit.

Regarding the semiconductor integrated circuit stated above, it is further noted that the logic unit also accesses the buffer unit.

Regarding the semiconductor integrated circuit stated above, the following is further noted. That is, an access to the data storage unit by a bus master unit that is required to respond in real-time may be assigned with a higher priority level. During the time no access request to the data storage unit by such a higher-priority the bus master unit is being executed, a portion of the available memory bandwidth may remain unused. In such a case, the logic unit is reconfigured into an arithmetic unit or a control unit each of which act as a bus master unit that only uses the unused portion of the memory bandwidth.

In another aspect of the present invention, a data storage unit for storing data to be transferred; a plurality of bus master units each for accessing the data storage unit; a data transfer control unit for managing data transfer requests individually issued by the respective bus master units and for accessing the data storage unit; a plurality of bus units A each connecting a different one of the bus master units to the data transfer control unit; and a bus unit B connecting the data transfer control unit with the data storage unit. Each of the plurality of bus master units performs data transfer via a corresponding one of the bus units A, the data transfer control unit, and the bus unit B. The semiconductor integrated circuit further includes a memory bandwidth monitoring unit, a reconfiguration unit, and a reconfiguration control unit. The memory bandwidth monitoring unit monitors the memory bandwidth required by each of the bus master units to access the data storage unit via a corresponding one of the bus units A, the data transfer control unit, and the bus unit B. The reconfiguration unit is connected to the data transfer control unit with bus-connection similarly to the plurality of bus master units. The reconfiguration control unit controls the reconfiguration unit based on output information received from the memory bandwidth monitoring unit. The reconfiguration unit configures both a logic unit and a buffer unit. The logic unit acts as an arithmetic unit or a control unit, whereas the buffer is for temporarily storing temporarily storing data be later stored to or read from the data storage unit by the plurality of bus master unit.

This structure enables to optimally configure a bus master and a buffer depending on the usage condition of the memory bandwidth. More specifically, an access to the data storage unit by a bus master unit that is required to respond in real-time may be assigned with a higher priority level. During the time no access request to the data storage unit by such a higher-priority the bus master unit is being executed, a portion of the available memory bandwidth may remain unused. In such a case, the bus master is optimally configured to only use the unused portion of the memory bandwidth and the buffer is used for temporally storing data be later stored to or read from the data storage unit. With the above arrangement, the memory bandwidth is effectively used without requiring increase in the buffer resource and thus at low cost.

According to the present invention, if an arithmetic unit or a control unit is currently being an unnecessary or excess unit during the system operation, the reconfiguration circuit dynamically allows to use such an excess unit as a buffer. This arrangement ensures the effective use of the memory bandwidth at low cost.

### INDUSTRIAL APPLICABILITY

The present invention is usable to such a consumer appliance having a system LSI including a bus master unit and a reconfigurable logic. The bus master is required to respond in real time and assigned with a priority level with respect to an access request to a data storage unit. The consumer appliance also has a reconfigurable logic. During the time no access request to the data storage unit by the bus master unit is being executed and a portion of the available memory bandwidth remains unused, the reconfigurable logic is altered into another bus master unit that only uses the unused portion of the memory bandwidth.

1. A data transfer control device for controlling transfer of data to and from an external device, the data transfer control device comprising:
a reconfiguration unit having a plurality of reconfigurable circuit cells;
an internal device operable to output a data transfer request;
a transfer control unit operable to relay data transferred between the internal device and the external device and to acquire reconfiguration information defining a circuit assisting the data transfer, the circuit being determined depending on a memory bandwidth required by the data transfer request; and
a reconfiguration control unit operable to control the reconfiguration unit to configure the circuit according to the acquired reconfiguration information.

2. The data transfer control device of claim 1, wherein
the data transfer control unit is operable to acquire the reconfiguration information if the memory bandwidth is equal to or greater than a predetermined threshold, and
the reconfiguration control unit is operable to control the reconfiguration unit to configure the circuit according to the reconfiguration information.

3. The data transfer control device of claim 2, wherein
the transfer control unit is operable to acquire the reconfiguration information defining the circuit acting as a buffer unit operable to temporarily store data requested to be transferred by the data transfer request, and
the reconfiguration control unit is operable to control the reconfiguration unit to configure the circuit acting as the buffer unit.

4. The data transfer control device of claim 3, wherein
the reconfiguration information additionally defines a circuit acting as one of an arithmetic unit and a control unit, and
the reconfiguration control unit is operable to control the reconfiguration unit to additionally configure the circuit acting as a corresponding one of the arithmetic unit and the control unit.

5. The data transfer control device of claim 4, further comprising:
a status holding unit operable to hold, immediately prior to reconfiguration by the reconfiguration unit, a processing status of each circuit currently preset in the reconfiguration unit.

6. The data transfer control device of claim 5, wherein
the reconfiguration unit is operable to reconfigure the previously configured circuits, by using the processing status held in the processing status holding unit.

7. The data transfer control device of claim 1, wherein
the transfer control unit is operable to acquire, if the memory bandwidth is smaller than a predetermined threshold, the circuit reconfiguration information defining the circuit acting as one of an arithmetic unit and a control unit, and
the reconfiguration control unit is operable to control, if the memory bandwidth is smaller than the predetermined threshold, the reconfiguration unit to configure the circuit acting as a corresponding one of the arithmetic unit and the control unit.

8. The data transfer control device of claim 1, wherein
the transfer control unit is operable to (i) acquire, if the memory bandwidth is smaller than a predetermined threshold, the reconfiguration information defining the circuit acting as one of an arithmetic unit and a control unit and (ii) acquire, if the memory bandwidth is equal to or greater than the predetermined threshold, the reconfiguration information defining the circuit acting as a buffer unit operable to temporarily store data requested to be transferred by the data transfer request,
the reconfiguration control unit is operable to (i) control, if the memory bandwidth is smaller than the predetermined threshold, the reconfiguration unit to configure the circuit to configure the circuit acting as a corresponding one of the arithmetic unit and the control unit and (ii) control, if the memory bandwidth is equal to or greater than the predetermined threshold, the reconfiguration unit to configure the circuit to acting as the buffer unit, and
the data transfer control device further comprises:
a status holding unit operable to hold, immediately prior to reconfiguration by the reconfiguration unit, a processing status of each circuit currently present in the reconfiguration unit.

9. The data transfer control device of claim 8, wherein
if any memory bandwidth remains unused during a time period in which no data transfer request issued by the internal device is being executed, the reconfiguration unit is operable to reconfigure the circuit acting as the corresponding one of the arithmetic unit and the control units that only uses the remaining memory bandwidth.

10. The data transfer control device of claim 1, wherein
the transfer control unit is operable to (i) acquire, if the memory bandwidth is smaller than a predetermined threshold, the reconfiguration information defining the circuit acting as one of an arithmetic unit and a control unit and (ii) acquire, if the memory bandwidth is equal to or greater than the predetermined threshold, the reconfiguration information defining the circuit acting as one of the arithmetic unit and the control unit and additionally defining a circuit acting as a buffer unit operable to temporarily store data requested to be transferred by the data transfer request, and
the reconfiguration control unit is operable to (i) control, if the memory bandwidth is smaller than the predetermined threshold, the reconfiguration unit to configure the circuit acting as a corresponding one of the arithmetic unit and the control unit, and (ii) control, if the memory bandwidth is equal to or greater than the predetermined threshold, the reconfiguration unit to configure the circuit acting as a corresponding one of the arithmetic unit and the control unit and additionally configure the circuit acting as the buffer unit.

11. The data transfer control device of claim 10, further comprising:
a status holding unit operable to hold, immediately prior to reconfiguration by the reconfiguration unit, a processing status of each circuit currently present in the reconfiguration unit.

12. The data transfer control device of claim 10, wherein.
the transfer control unit is operable to acquire, if the memory bandwidth is equal to or greater than the predetermined threshold, the reconfiguration information defining the circuit acting as one of the arithmetic unit and the control unit operable to access the buffer unit, and
the reconfiguration control unit is operable to control, if the memory bandwidth is equal to or greater than the predetermined threshold, the reconfiguration unit to configure the circuit acting as the corresponding one of the arithmetic unit and the control unit operable to access the buffer unit.

13. The data transfer control device of claim 12, wherein
if the transfer request issued by the internal device that is required to respond in real-time is assigned with a high priority level and any memory bandwidth remains unused during a time period in which no data transfer request issued by the internal device is being executed, the reconfiguration unit is operable to configure the corresponding one of the arithmetic unit and the control units that only uses the remaining memory bandwidth.

14. A data transfer device for transferring data between internal devices, the data transfer device comprising:
a reconfiguration unit having a plurality of reconfigurable circuit cells;
a first device operable to output a data transfer request;
a second device being a destination of data transfer requested by the data transfer request;
a transfer control unit operable to relay data transferred between the first and second devices and to acquire reconfiguration information defining a circuit assisting the data transfer, the circuit being determined depending on a memory bandwidth required by the data transfer request; and
a reconfiguration control unit operable to configure the circuit according to the acquired reconfiguration information.

15. The data transfer device of claim 14, wherein
the data transfer device is a real-time device for performing real-time processing,
the second device is a storage device operable to store data, and
the first device is required to respond in real-time and operable to output a request to read or write data to or from the storage device.

16. A semiconductor integrated circuit for relaying data transferred between an internal device and an external device that is a destination of requested data transfer, the semiconductor integrated circuit comprising:
a reconfiguration unit having a plurality of reconfigurable circuit cells;
the internal device operable to output a data transfer request;
a transfer control unit operable to relay data transferred between the internal device and the external device and to acquire reconfiguration information defining a circuit assisting the data transfer, the circuit being determined depending on a memory bandwidth required by the data transfer request; and
a reconfiguration control unit operable to control the reconfiguration unit to configure the circuit according to the acquired reconfiguration information.

17. A data transfer control method for use by a semiconductor integrated circuit, the semiconductor integrated circuit (i) including a reconfiguration unit having a plurality of reconfigurable circuit cells and (ii) relaying data transferred between a first device that outputs a data transfer request and a second device that is a destination of requested data transfer, the data transfer control method comprising:
a transfer control step of relaying data transferred between the internal device and the external device and acquiring reconfiguration information defining a circuit assisting the data transfer, the circuit being determined depending on a memory bandwidth required by the data transfer request; and
a reconfiguration step of controlling the reconfiguration unit to configure the circuit according to the acquired reconfiguration information.
